(19) United States
(12) Patent Application Publication
(10) Pub. No.: US 2021/0256740 A1
(43) Pub. Date: Aug. 19, 2021

(54) METHOD FOR INCREASING POINT CLOUD SAMPLING DENSITY, POINT CLOUD PROCESSING SYSTEM, AND READABLE STORAGE MEDIUM

(71) Applicant: SZ DJI TECHNOLOGY CO., LTD., Shenzhen (CN)

(72) Inventors: Yanzhao LI, Shenzhen (CN); Fu ZHANG, Shenzhen (CN); Han CHEN, Shenzhen (CN)

(73) Assignee: SZ DJI TECHNOLOGY CO., LTD., Shenzhen (CN)

(21) Appl. No.: 17/308,056

(22) Filed: May 5, 2021

Related U.S. Application Data
(63) Continuation of application No. PCT/CN2019/074630, filed on Feb. 2, 2019.

(51) Int. Cl. G06T 11/00

(52) U.S. Cl. CPC G06T 11/006

(57) ABSTRACT

A method for increasing point cloud sampling density, a point cloud processing system, and a readable storage medium. The method for increasing point cloud sampling density includes operations that performing a projection transformation on a three-dimensional first point cloud based on a given plane to obtain a first planar image, inserting a plurality of pixel points in the blank area based on a pixel point around a blank area in the first planar image to obtain a second planar image, and performing an inverse projection transformation on the second planar image to obtain a reconstructed three-dimensional second point cloud. This disclosure replaces the insertion point in the three-dimensional point cloud with the insertion of the pixel point in the planar image, which can reduce the difficulty of data inserting.

### CROSS-REFERENCE TO RELATED APPLICATION

The present application is a continuation of International Application No. PCT/CN2019/074630, filed Feb. 2, 2019, the entire contents of which is incorporated herein by reference in its entirety.

### TECHNICAL FIELD

The present disclosure relates to the technical field of control, and more particularly, to a method for increasing point cloud sampling density, a point cloud processing system, and a non-transitory computer-readable storage medium.

### BACKGROUND

As part of a process of spatial scanning, a laser radar system may obtain a sampling pattern of the space using point cloud technology. In the situation of having the same sampling pattern, more sampling points could lead to a denser point cloud; and in the situation of having the same sampling points, a more uniform sampling pattern could render a better field of view (FOV). Hence, as much point cloud sampling density as possible may be desirable.

Two ways to increase point cloud sampling density are described in the related arts.

The first way is to improve the hardware scheme by systematically increasing the sampling frequency and improving the sampling pattern. For example, a multi-channel mode is used to achieve a parallel acquisition, and the sampling frequency and the sampling pattern can be improved in a multiplied manner, thereby improving the point cloud density. However, this way may require a large difficulty in building hardware, and the power consumption of the laser radar system also can be increased.

The second way is to improve the point cloud sampling density by performing a software interpolation, such as nearest neighbor difference or linear interpolation, in three-dimensional space. Due to the characteristic of point cloud sparsity when acquiring the point cloud pattern in three-dimensional space, the effect and adaptability of the direct interpolation can be poor. In addition, the noise points present in the point cloud pattern can also cause interpolation errors and further worsen the effect of the point cloud pattern.

### SUMMARY

Embodiments of the present disclosure provide a method for increasing point cloud sampling density, a point cloud processing (e.g., scanning) system, and a non-transitory computer-readable storage medium.

In a first aspect, the present disclosure provides a method for increasing point cloud sampling density. The method can include based on a given plane, performing a projection transformation on a three-dimensional first point cloud to obtain a first planar image; based on pixel points around a blank area in the first planar image, inserting a plurality of pixel points into the blank area to obtain a second planar image; and performing an inverse projection transformation on the second planar image to obtain a reconstructed three-dimensional second point cloud.

In a second aspect, embodiments of the present disclosure provide a point cloud processing system, which can include a memory and a processor. The memory is connected to the processor by a communication bus to store computer instructions executable by the processor. The processor can be configured to, based on a given plane, perform a projection transformation on a three-dimensional first point cloud to obtain a first planar image; based on pixel points around a blank area in the first planar image, insert a plurality of pixel points into the blank area to obtain a second planar image; and perform an inverse projection transformation on the second planar image to obtain a reconstructed three-dimensional second point cloud.

In a third aspect, embodiments of the present disclosure provide a non-transitory computer-readable storage medium, being stored computer instructions thereon. The computer instructions can be executed by one or more processors to implement the operations of the first aspect.

### BRIEF DESCRIPTION OF THE DRAWINGS

The accompanying drawings, which are incorporated herein and form a part of the specification, illustrate implementations of the present disclosure and, together with the description, further serve to explain the present disclosure and to enable a person skilled in the pertinent art to make and use the present disclosure.

FIG. 1 is a block diagram of a point cloud processing system according to an embodiment of the present disclosure;

FIG. 2 is a schematic structural diagram of a distance detection device employing a coaxial optical path according to an embodiment of the present disclosure;

FIG. 3 is a diagram of an exemplary point cloud scanning trajectory according to an embodiment of the present disclosure;

FIG. 4 is a flowchart of a method for increasing point cloud sampling density according to an embodiment of the present disclosure;

FIG. 5 is a block diagram showing states of a point cloud at different stages according to an embodiment of the present disclosure;

FIG. 6 is a schematic diagram of a given plane as a projection surface according to an embodiment of the present disclosure;

FIG. 7 is a flowchart of a method for obtaining a second planar image according to an embodiment of the present disclosure;

FIG. 8 is a schematic diagram of acquiring objects on the first planar image according to an embodiment of the present disclosure;

FIG. 9 is a schematic diagram of obtaining a blank area on an object in the first planar image according to an embodiment of the present disclosure;

FIG. 10 is a schematic diagram of an acquisition region of the first planar image according to an embodiment of the present disclosure;

FIG. 11 is a schematic diagram of obtaining a blank area in another acquisition area according to an embodiment of the present disclosure;

FIG. 12 is a flow chart of a method for inserting physical parameters into a target point in the blank area according to an embodiment of the present disclosure;

FIG. 13 is a flowchart of a method for determining the target point according to an embodiment of the present disclosure;

FIG. 14 is an effect diagram of the second point cloud according to an embodiment of the present disclosure;

FIG. 15 is a flowchart of another method for increasing point cloud sampling density according to an embodiment of the present disclosure;

FIG. 16 is a block diagram of states of the point cloud at different stages according to an embodiment of the present disclosure;

FIG. 17 is a flowchart of a method for acquiring a third point cloud according to an embodiment of the present disclosure;

FIG. 18 is a flowchart of another method for increasing point cloud sampling density according to an embodiment of the present disclosure;

FIG. 19 is a block diagram of states of the point cloud at different stages according to an embodiment of the present disclosure;

FIG. 20 is a flowchart of another method for increasing point cloud sampling density according to an embodiment of the present disclosure;

FIG. 21 is a block diagram of states of the point cloud at different stages according to an embodiment of the present disclosure; and

FIG. 22 is a block diagram of another point cloud processing system according to an embodiment of the present disclosure.

Implementations of the present disclosure will be described with reference to the accompanying drawings.

### DETAILED DESCRIPTION

The technical solutions in the embodiments of the present disclosure will be described in connection with the accompanying drawings in the embodiments of the present disclosure, notably where the described embodiments are merely a part of the disclosure, and not all embodiments. Based on the embodiments of the present disclosure, all other embodiments without creative efforts are within the scope of the present disclosure.

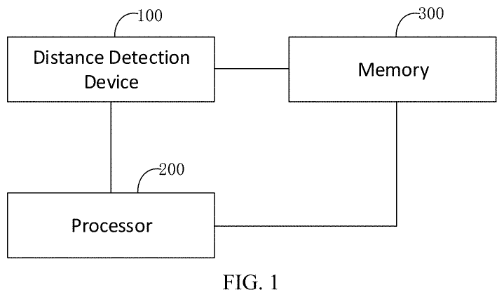

To solve some or all of the above problems discussed in the Background section, the present disclosure can provide a point cloud processing system. According to one or more embodiments, the point cloud processing system can be a point cloud scanning system. FIG. 1 is a block diagram of a point cloud processing system according to an embodiment of the present disclosure. Referring to FIG. 1, the point cloud processing system can include a distance detection device 100, a processor 200, and a memory 300, wherein the processor 200 may be respectively connected to the distance detection device 100 and the memory 300, and distance detection device 100 can be connected to the memory 300. Distance detection device 100 can be used for acquiring the point cloud and sending the point cloud to memory 300 and/or processor 200. It is understood that distance detection device 100 can be integrated in the point cloud processing system or can also be separately arranged to output the point cloud through the connection between the point cloud processing system. The following descriptions are illustrated by embodiments that distance detection device 100 is disposed within the point cloud processing system.

Embodiments of the present disclosure can also provide a method for increasing the point cloud sampling density. Processor 200 can execute the method for increasing the point cloud sampling density when receiving the point cloud, so as to achieve the effect of increasing the point cloud sampling density. Processor 200 may then send the reconstructed point cloud to memory 300 for storage.

In some embodiments, the distance detection device 100 may include a radar, such as a lidar. The distance detection device 100 may detect the distance of a detected object to the distance detection device 100 by measuring the time of light propagation between the distance detection device 100 and the detected object, i.e., a time-of-flight (TOF).

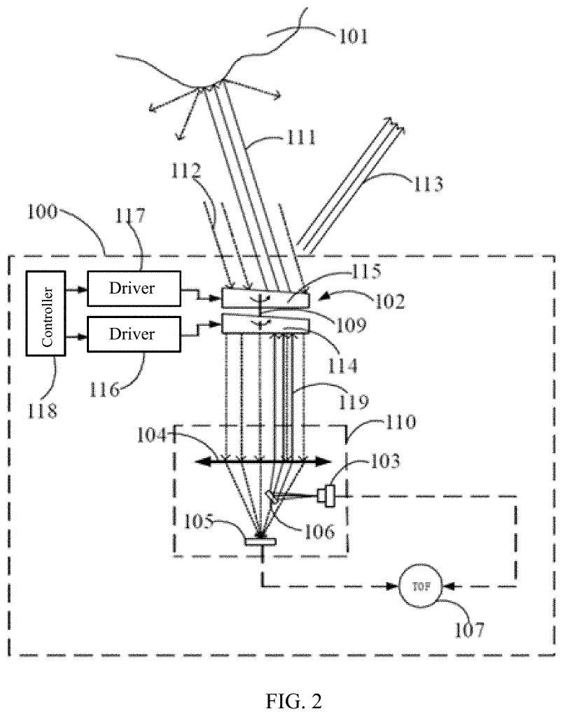

A coaxial optical path may be employed in the distance detection device 100, and the light beam emitted by the distance detection device 100 and the reflected light beam share at least a portion of the optical path within the distance detection device. Alternatively, the distance detection device 100 may also employ an off-axis optical path, and the light beam emitted by the distance detection device 100 and the reflected light beam can be transmitted along different optical paths within the distance detection device, respectively. FIG. 2 is a schematic structural diagram of the distance detection device 100 employing a coaxial optical path according to an embodiment of the present disclosure.

Referring to FIG. 2, distance detection device 100 can include an optical transceiver 110 that includes a light source 103, a collimating element 104, a detector 105, and a light path changing element 106. Optical transceiver 110 can be used to emit a light beam and receive the reflected light and convert the reflected light into an electrical signal. Light source 103 can emit a light beam. In some embodiments, light source 103 may emit a laser beam. Light source 103 may include a laser diode packaging module 106 (as the light path changing element 106) for emitting laser pulses in a direction at an inclined angle with the first surface of the substrate of laser diode packaging module 106, wherein the inclined angle is less than or equal to 90 degrees. Optionally, the laser beam emitted by light source 103 is a narrow bandwidth beam of wavelengths outside of the visible range. Collimating element 104 is disposed on the emergent light path of light source 103 for collimating the light beam emitted from light source 103 into parallel light. Collimating element 104 can also be used to converge at least a portion of the light reflected by the detected object. Collimating element 104 may be a collimating lens or other element capable of collimating the light beam.

Distance detection device 100 can further comprise a processing module 102, which may be, according to one or more embodiments of the disclosed subject matter, a scanning module 102, and the processing module 102 can be placed on the emergent light path of optical transceiver 110. Processing module 102 can be used for changing the transmission direction of a collimated light beam 119 emitted by collimating element 104 and projecting collimated light beam 119 to the external environment, and projecting the reflected light onto collimating element 104. The reflected light is converged to detector 105 through collimating element 104.

In some embodiments, the processing module 102 may include one or more optical elements, such as lenses, mirrors, prisms, gratings, optical phased arrays, or any combination of the foregoing. In some embodiments, the plurality of optical elements of processing module 102 may rotate about a common rotation axis 109. Each rotating optical element can be used to constantly change the direction of propagation of the incident light beam. In one embodiment, the plurality of optical elements of processing module 102 may rotate at different speeds. In another embodiment, the plurality of optical elements of processing module 102 may rotate at substantially the same speed.

In some embodiments, the plurality of optical elements of processing module 102 may also be rotated about different axes, or vibrate in the same direction, or vibrate in different directions.

In one embodiment, processing module 102 includes a first optical element 114 and a driver 116 connected to first optical element 114. Driver 116 may include a motor or other driving devices for driving first optical element 114 to rotate about rotation axis 109 such that first optical element 114 changes the direction of collimated light beam 119. First optical element 114 projects collimated beam 119 to a different direction. In one embodiment, the angle between collimated light beam 119 after first optical element 114 and rotation axis 109 changes with the rotation of first optical element 114. In one embodiment, first optical element 114 includes a pair of opposing non-parallel surfaces through which collimated beam 119 passes. In one embodiment, first optical element 114 includes a prism that varies in thickness along at least one radial direction. In one embodiment, first optical element 114 includes a wedge prism that refracts collimated beam 119. In one embodiment, first optical element 114 is plated with an antireflection film, and the thickness of the antireflection film is equal to the wavelength of the light beam emitted by light source 103 to increase the intensity of the transmitted light beam.

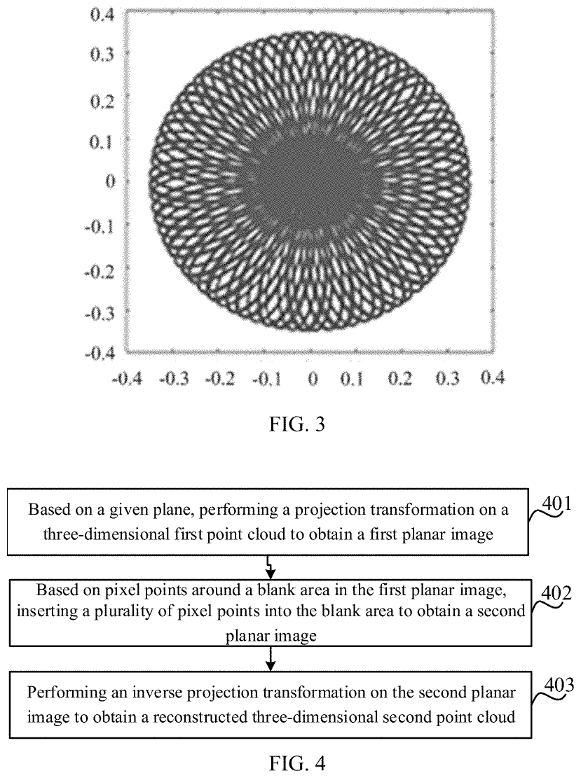

In one embodiment, processing module 102 further includes a second optical element 115 that rotates about the rotation axis 109. The rotational speed of second optical element 115 can be different from the rotational speed of first optical element 114. Second optical element 115 can be used to change the direction of the light beam projected by first optical element 114. In one embodiment, second optical element 115 is connected to another driver 117. Driver 117 may include a motor or other drive to drive second optical element 115 to rotate. First optical element 114 and second optical element 115 can be driven by different drivers, so that the rotating speeds of first optical element 114 and second optical element 115 are different. Therefore, collimated light beam 119 can be projected to a different direction from the external environment, and a larger spatial range can be scanned. In one embodiment, a controller 118 controls driver 116 and driver 117 to drive the rotational speeds of first and second optical elements 114 and 115, respectively. The rotational speeds of first and second optical elements 114 and 115 may be determined according to the region and style of the desired scan in the actual application. For example, adjusting the rotational speed of first optical element 114 and second optical element 115 may result in the exemplary point cloud scanning trajectory diagram shown in FIG. 3.

In one embodiment, second optical element 115 includes a pair of opposing non-parallel surfaces through which the light beam passes. In one embodiment, second optical element 115 includes a prism that varies in thickness along at least one radial direction. In one embodiment, second optical element 115 includes a wedge prism. In one embodiment, second optical element 115 is plated with an antireflection film capable of increasing the intensity of the transmitted light beam.

Rotation of the processing module 102 may project light to different orientations, such as the direction 111 and the direction 113, to scan the space around distance detection device 100. When the light beam projected by processing module 102 strikes a detected object 101 along direction 111, a portion of the light can be reflected by detected object 101 in a direction opposite to the projected light beam to distance detection device 100. Processing module 102 receives the reflected light 112 reflected by detected object 101 and projects reflected light 112 to collimating element 104.

Collimating element 104 converges at least a portion of the light reflected by detected object 101. In one embodiment, collimating element 104 is plated with an antireflection film capable of increasing the intensity of the transmitted light beam. Detector 105 and light source 103 are placed on the same side of collimating element 104 for converting at least a portion of the reflected light passing through collimating element 104 into an electrical signal.

In some embodiments, light source 103 may include a laser diode that emits a nanosecond-level laser through the laser diode. For example, the laser pulse emitted by light source 103 can last for 10 ns. Further, the laser pulse reception time may be determined, for example, by detecting a rising edge time and/or a falling edge time of the electrical signal pulse. As such, the distance detection device 100 may calculate the TOF 107 using the pulse reception time information and the pulse emitting time information, thereby determining the distance of detected object 101 to distance detection device 100.

The distance and orientation detected by distance detection device 100 may be used for remote sensing, obstacle avoidance, mapping, modeling, navigation, and the like.

In one embodiment, distance detection device 100 may calculate one or more physical parameters of the point on the detected object 101 from the reflected light of different directions. Wherein the one or more physical parameters may include at least one of a distance, a depth value, a reflectivity, a direction, an angle value and color information. The coordinate data of the reflected light of different directions corresponding to the image plane of the distance detection device can obtain a point in a three-dimensional space, namely Pi={Xi, Yi, Zi, . . . }, where ellipses represent physical parameters, which are also called scan points in subsequent embodiments. Then, the points of different directions constitute point cloud, that Point Cloud={P1, P2, P3, . . . , Pn}. It is understood that the point cloud is a collection of points of a three-dimensional structure, which is subsequently called the first point cloud.

In one embodiment, when processor 200 receives the point cloud data sent by distance detection device 100, a method for increasing the point cloud sampling density is performed, and FIG. 4 is a flowchart of the method for increasing point cloud sampling density according to an embodiment of the present disclosure. Referring to FIG. 4, the method for increasing point cloud sampling density can include operations 401-403:

Operation 401 can include, based on a given plane, performing a projection transformation on a three-dimensional first point cloud to obtain a first planar image.

In the present embodiment, processor 200 first obtains a given plane. The given plane has a mapping relationship with the image plane of distance detection device 100, and the mapping relationship is a mathematical relationship of translation and/or rotation between the given plane and the image plane. In one embodiment, the given plane is the image plane of distance detection device 100, so that the subsequent process can be simplified. Specifically, processor 200 may send a request to distance detection device 100 to require the given plane, and distance detection device 100 sends its image plane to processor 200 in response to the request, as the given plane of processor 200. Of course, the image plane of distance detection device 100 may also be stored in memory 300 in advance, and processor 200 reads from memory 300 when the given plane is needed.

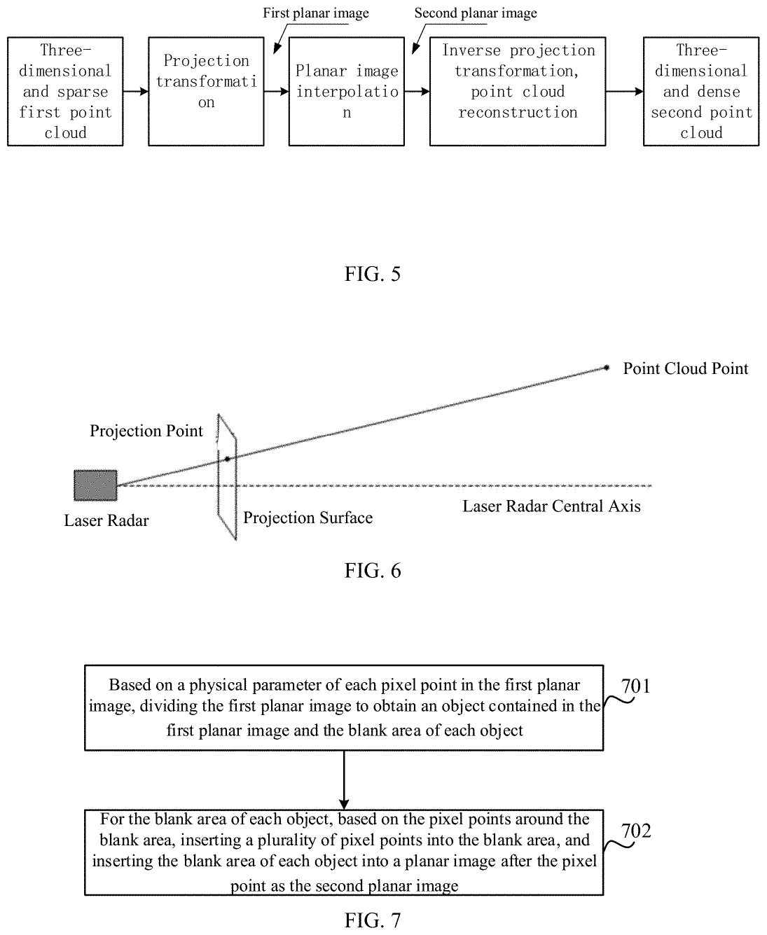

In the present embodiment, referring to FIG. 5, processor 200 can perform the projection transformation on a three-dimensional first point cloud based on the given plane, and can convert the three-dimensional point cloud to a two-dimensional point cloud to obtain a first planar image.

In the present embodiment, the projection transformation may be implemented in a variety of ways. In one example, the given plane is used as a projection surface and the position of the distance detection device 100 (such as a laser radar) can be used as a center point. The points of the first point cloud are subjected to perspective projection to the given plane to obtain projection points located on the given plane.

For example, as shown in FIG. 6, the given plane (i.e., projection plane) can be a plane perpendicular to the central axis of the light pulse sequence emitted by the detection device. The given plane can also be an image plane of the distance detection device 100, or other suitable plane, and can serve as a projection surface with the given plane. The position of the detection distance device 100 (such as a laser radar) is used as a center point, and the points of the first point cloud are subjected to perspective projection to the reference surface to obtain projection points located on the reference surface.

Referring to operation 402 of FIG. 4, this operation can include, based on pixel points around a blank area in the first planar image, inserting a plurality of pixel points into the blank area to obtain a second planar image.

In this embodiment, processor 200 obtains a blank area in the first planar image. The ways to obtain the blank area may include:

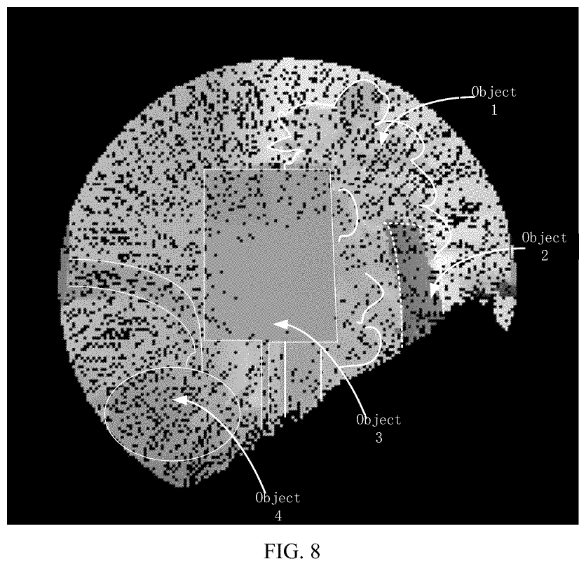

For the first way, referring to FIG. 7, processor 200 divides the first planar image according to the physical parameters of each pixel point in the first planar image to obtain an object contained in the first planar image and a blank area in each object (corresponding to operation 701). Then, for the blank area of each object, processor 200 inserts a plurality of pixel points in the blank area according to the pixel points around the blank area, and the planar image after the insertion is used a second planar image (corresponding to operation 702).

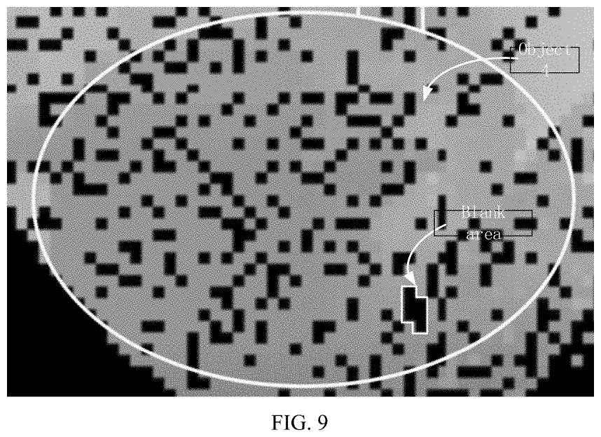

FIG. 8 is a schematic diagram of acquiring objects on the first planar image according to an embodiment of the present disclosure. Referring to FIG. 8, by using the physical parameter, including a depth value, of each point in the first planar image as an example, processor 200 may scan each point in the first planar image to obtain a depth value for each point. Processor 200 may then divide the object 1, the object 2, the object 3, and the object 4 contained in the first planar image according to the depth value of each point.

In an embodiment, the ways in which processor 200 divides the first planar image may include at least one of semantic segmentation and instance segmentation. The semantic segmentation can refer to segmenting and identifying content (i.e., objects) in the image and making corresponding annotations. The same object labels can be the same. Instance segmentation can refer to segmenting and identifying content (i.e., objects) in an image, each object corresponding to one annotation. The appropriate way may be selected according to the specific scenarios and are not limited here.

FIG. 9 is a schematic diagram of obtaining a blank area on an object in the first planar image according to an embodiment of the present disclosure. Referring to FIG. 9, by using object 4 as an example, processor 200 may determine at least one blank area included in the first planar image according to the depth value of each point in object 4. For example, processor 200 takes one of the points A (i.e., any point in the object 4) as a starting point and then diffuses around. If there is a point around point A, then point A is not a boundary point, and point A is not related to blank area. In this case, processor 200 updates the starting point and iterates the above steps until the beginning of the blank area boundary is found. The boundary points of the blank area continue to be detected from adjacent points of the starting point until a closed blank area is obtained, as shown in FIG. 9.

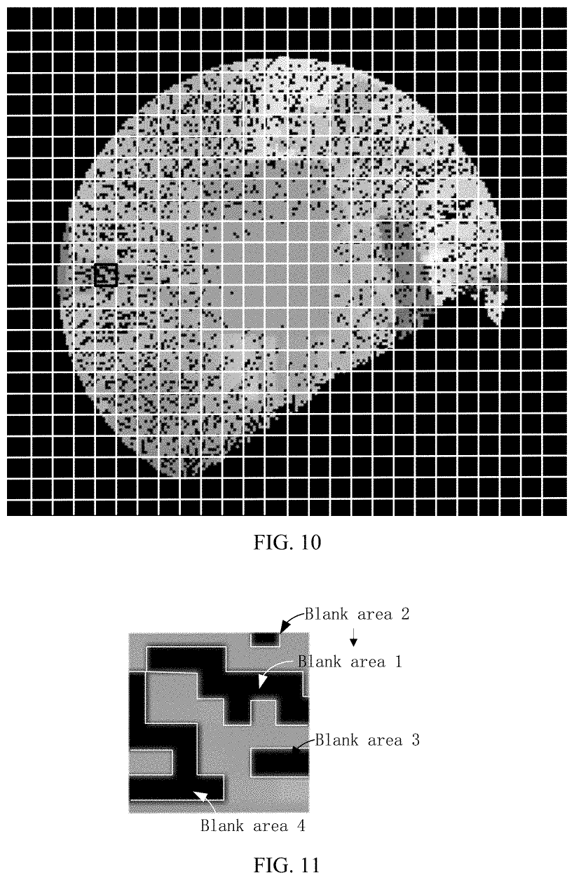

For the second way, referring to FIG. 10, processor 200 divides the first planar image into a plurality of regions, the plurality of regions may be the same in area, may be the same in partial region, or may be different. Then, for each region, using a region within the rectangular area in FIG. 11 as an example, processor 200 obtains a blank area 1, a blank area 2, a blank area 3, and a blank area 4.

It should be noted that the foregoing partitioning modes or other partitioning modes according to a specific scenario to divide the first planar image, and in the case that the blank area can be determined, the corresponding scheme also falls within the scope of the present application.

In the present embodiment, for each blank area, processor 200 obtains the pixel points around the blank area and inserts a plurality of pixel points in the blank area according to the physical parameters of the surrounding pixel points, so that the second planar image can be obtained.

When distance detection device 100 emits a light beam into the scene space, since the light beam directed toward the sky does not reach a detected object, the distance detection device 100 receives no echo information. At this time, the depth value of the point cannot be obtained and the corresponding point in this case is referred to as the sky point. In other words, neither the sky point nor the point in the first planar image that is not scanned by the distance detection device 100 (i.e., the unscanned point) does not have a depth value, so that the two points can be included when the blank area is divided.

In one embodiment, referring to FIG. 12, after determining the blank area in the first planar image according to the point in the first planar image (corresponding to operation 1201), processor 200 may obtain the point to be inserted in the blank area according to a preset step size or sequentially obtain the point to be inserted in the blank area. Processor 200 may then determine whether the point to be inserted is a scanned point. This is because, for a sky point, the processor 200 may not need to insert data, but for a non-scanned point, the insertion may be needed. Hence, embodiments of the disclosed subject matter can determine whether the point to be inserted is a sky point or a non-scanned point before the data is inserted, i.e., whether the point where the data to be inserted is a target point (corresponding to operation 1202).

In one embodiment, if the point to be inserted is the sky point, then the point to be inserted is not the target point and no data will be inserted. In another embodiment, if the point to be inserted is a non-scanned point, the point to be inserted is the target point, and data is required to be inserted. At this time, processor 200 determines the value of the physical parameter of the target point according to a preset algorithm (correspond to operation 1203). In this embodiment, the preset algorithm may an interpolate algorithm. The interpolation algorithm may be, for example, at least one of a nearest neighbor interpolation, a linear interpolation, a Lanczos interpolation algorithm, an inverse distance weighting method, a spline interpolation method, a discrete smoothing interpolation, and a trend face smooth interpolation.

In one embodiment, processor 200 can determine whether a point to be inserted in the blank area is a target point and may include the following ways:

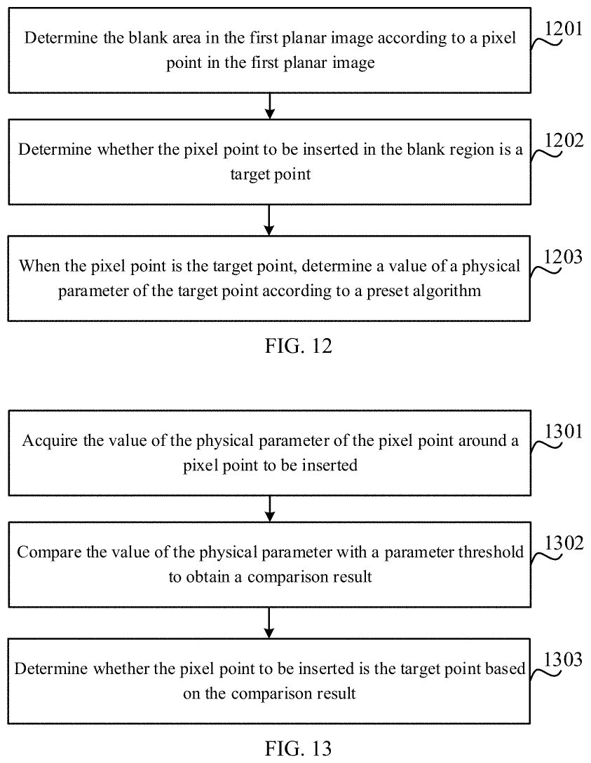

The first way, referring to FIG. 13, processor 200 obtains values of a physical parameter of pixel points around a pixel point to be inserted (corresponding to operation 1301). The number of surrounding pixel points may be selected to be 4, 8, or more, which is not limited here. Processor 200 then compares the values of the physical parameters and the parameter thresholds to obtain a comparison result (corresponding to operation 1302). Thereafter, processor 200 may determine whether the pixel point to be inserted is the target point (corresponding to operation 1303) based on the comparison result.

In one embodiment, processor 200 determines that the pixel point to be inserted is the target point when the comparison result indicates that the value of the physical parameter is less than or equal to the parameter threshold. When the comparison result indicates that the value of the physical parameter is greater than the parameter threshold, it is determined that the pixel point to be inserted is not the target point.

The second way is setting an identification when the sky point is detected during distance detection device 100 generating the first point cloud. Processor 200 may parse an identification in a physical parameter of a pixel point to be inserted, and determine whether the pixel point to be inserted is a target point based on the identification.

It should be noted that other ways according to a specific scenario can be used to determine whether the pixel point to be inserted is the target point, and in the case that the target point can be determined, the corresponding scheme can also fall within the claimed scope of the present application.

Referring to operation 403 of FIG. 4, this operation can include performing an inverse projection transformation on the second planar image to obtain a reconstructed three-dimensional second point cloud.

In the embodiment, processor 200 performs the inverse projection transformation on the second planar image, wherein the inverse projection transformation is the inverse operation of the projection transformation. In the case the projection surface and the depth value are determined, the position of each projection point can be restored by combining the projection transformation scheme, so that the reconstructed three-dimensional second point cloud can be obtained, and the density of the point in the second point cloud can be improved compared with the first point cloud. Processor 200 may then send the second point cloud to memory 300 for storage or to a display device for display.

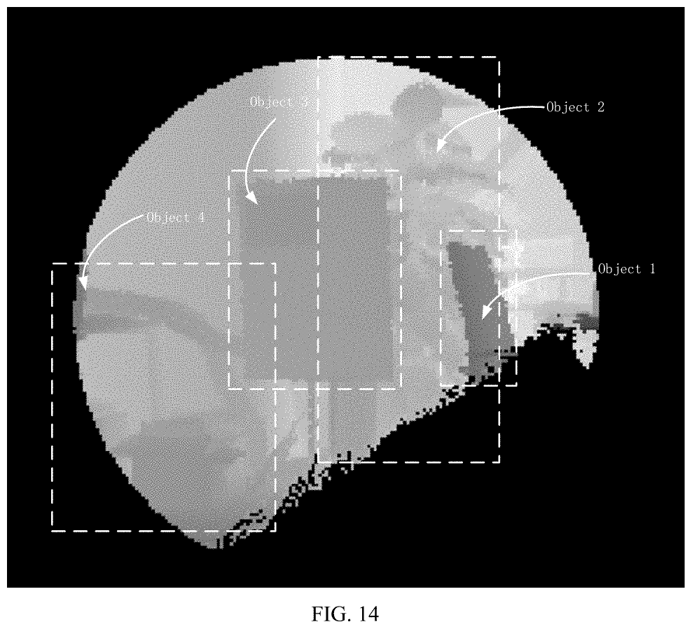

Referring to FIG. 14, after the second point cloud is displayed by the display device, the user can directly identify that four features are included in the scene space, for example, object 1 is a chair back, object 2 is a bonsai, object 3 is a blackboard, and object 4 is a chair handle.

Thus, in the present embodiment, the insertion point in the three-dimensional point cloud can be replaced by inserting the pixel point in the planar image, which can reduce the difficulty the operation of inserting data. Moreover, compared with the first point cloud, the density of the points in the second point cloud can be increased, the sparsity of the point distribution in the first point cloud can be reduced, and the user can conveniently observe objects in the corresponding scene according to the second point cloud.

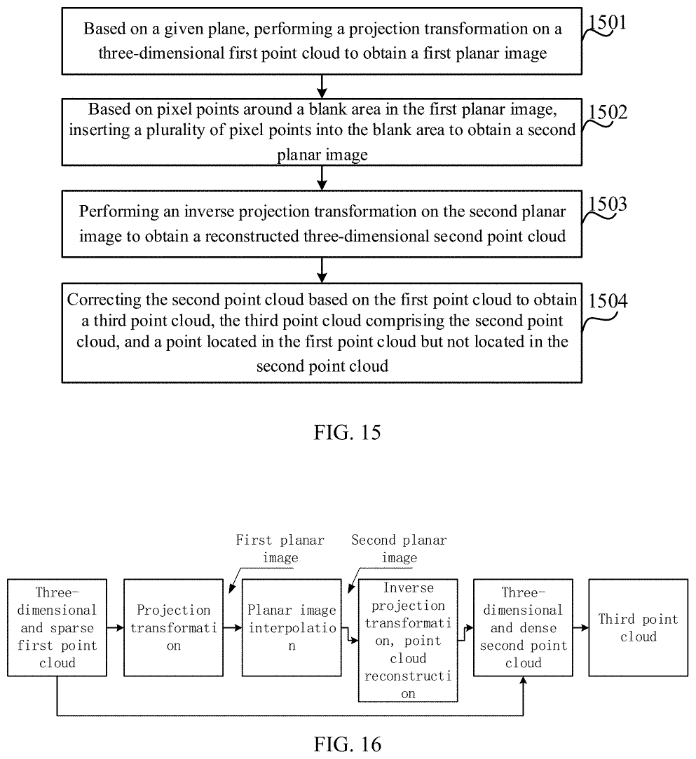

FIG. 15 is a flowchart of another method for increasing point cloud sampling density according to an embodiment of the present disclosure. FIG. 16 is a block diagram of states of the point cloud at different stages according to an embodiment of the present disclosure. Referring to FIGS. 15 and 16, a method for increasing point cloud sampling density can include operations 1501-1504:

Operation 1501, based on a given plane, can include performing a projection transformation on a three-dimensional first point cloud to obtain a first planar image.

The specific methods and principles of operation 1501 and operation 401 can be consistent, and the detailed description can be referred to the relevant contents of FIG. 4 and operation 401 and is not repeated here.

Operation 1502 can include, based on pixel points around a blank area in the first planar image, inserting a plurality of pixel points into the blank area to obtain a second planar image.

The specific methods and principles of operation 1502 and operation 402 can be consistent, and the detailed description can be referred to the relevant contents of FIG. 4 and operation 402 and is not repeated here.

Operation 1503 can include performing an inverse projection transformation on the second planar image to obtain a reconstructed three-dimensional second point cloud.

The specific methods and principles of operation 1503 and operation 403 can be consistent, and the detailed description can be referred to the relevant contents of FIG. 4 and operation 403 and is not repeated here.

Operation 1504 can include correcting the second point cloud based on the first point cloud to obtain a third point cloud. The third point cloud can comprise the second point cloud, and a point located in the first point cloud but not located in the second point cloud.

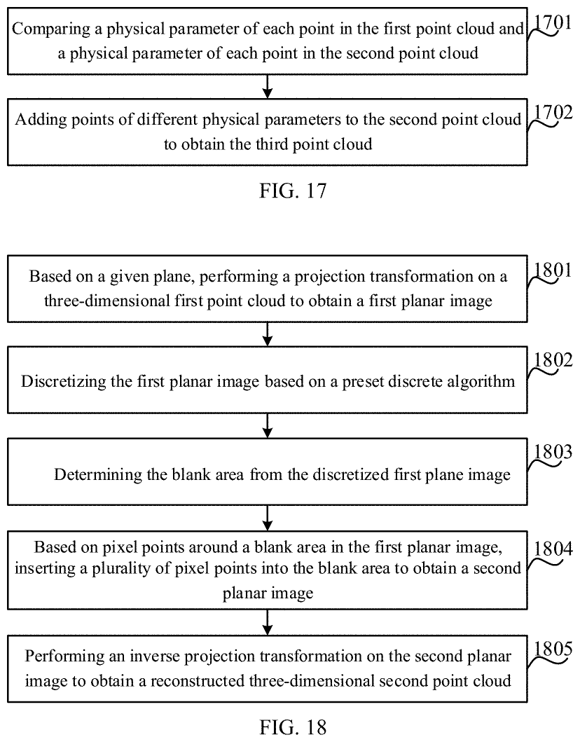

In one embodiment, processor 200 also corrects the second point cloud using the first point cloud. Referring to FIG. 17, processor 200 compares the physical parameters of the points in the first point cloud and the second point cloud (corresponding to operation 1701). If there are points in the second point cloud different from points in the first point cloud, the different points are corrected to the second point cloud to obtain the third point cloud. That is, the third point cloud includes all points in the second point cloud, and points located in the first point cloud but not located in the second point cloud (corresponding to operation 1702).

Thus, in the present embodiment, a plurality of points can be inserted into the first point cloud at a lower data insertion difficulty, which can result in a second point cloud having increased density of the points than in the first point cloud. Meanwhile, in the embodiment, by utilizing the first point cloud to correct the second point cloud and obtain the third point cloud, the density of the point in the third point cloud can be further increased, so that the sparsity of the point distribution in the first point cloud can be further reduced, and the user can conveniently observe objects in the corresponding scene according to the second point cloud.

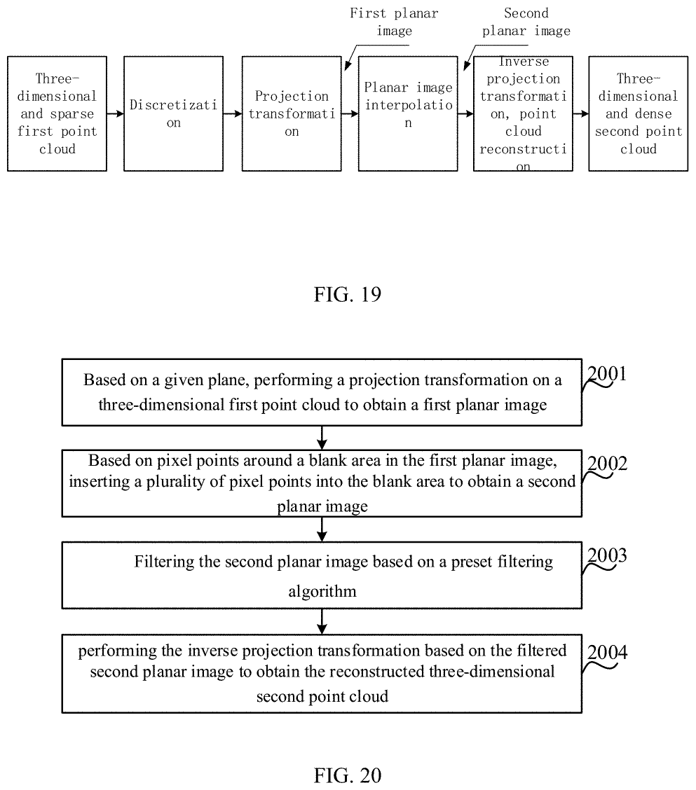

FIG. 18 is a flowchart of another method for increasing point cloud sampling density according to an embodiment of the present disclosure. FIG. 19 is a block diagram of states of the point cloud at different stages according to an embodiment of the present disclosure. Referring to FIGS. 18 and 19, a method for increasing point cloud sampling density can comprise operations 1801-1805:

Operation 1801 can include, based on a given plane, performing a projection transformation on a three-dimensional first point cloud to obtain a first planar image.

The specific methods and principles of operation 1801 and operation 401 can be consistent, and the detailed description can be referred to the relevant contents of FIG. 4 and operation 401 and is not repeated here.

Operation 1802 can include discretizing the first planar image based on a preset discrete algorithm.

In this embodiment, processor 200 discretizes the first planar image according to a preset algorithm. Specifically, processor 200 divides the first planar image into a plurality of regions, including a partial blank area. The blank area includes a region not including points in the first planar image.

The preset discrete algorithm can comprise at least one of a quadtree partitioning algorithm, a uniform segmentation algorithm, a normal segmentation algorithm, a semantic segmentation algorithm, and an example segmentation algorithm. Other discrete algorithms that, in the case of discretization of the first planar image, can also be implemented and fall within the scope of protection of the present application.

In one embodiment, the number of points contained within any two of the plurality of regions may be different. In one embodiment, the area of at least a portion of the plurality of regions may be different. In one embodiment, processor 200 may continue discretization of the regions. For example, if the number of points within one region is relatively large, the number of discretization may be increased until the resolution requirement is reached. As another example, if the number of points within one region is relatively small, the number of discretization may be reduced, or no discretization is performed. The number of discretization may be set according to a particular scenario, which is not limited here.

Operation 1803 can include determining the blank area from the discretized first planar image.

The specific methods and principles of operation 1803 and operation 402 can be consistent, and the detailed description can be referred to the relevant contents of FIG. 4 and operation 402 and is not repeated here.

Operation 1804 can include, based on pixel points around a blank area in the first planar image, inserting a plurality of pixel points into the blank area to obtain a second planar image.

In this embodiment, processor 200 determines the physical parameters of the pixel points inserted into the blank area according to the physical parameters of the pixel points in at least one adjacent region of the blank area.

In one embodiment, processor 200 determines a physical parameter of a pixel point inserted into the blank area according to a physical parameter of a point closest to the distance detection device in the at least one adjacent region. For example, the depth value of the closest point is taken as the depth value for the insertion pixel point.

In another embodiment, processor 200 may also determine the physical parameters of the pixel points inserted within the blank area according to an average value of the physical parameters of the points in the at least one neighboring region. For example, the average value of the physical parameter is taken as the value of the physical parameter that is inserted into the pixel point.

In another embodiment, processor 200 may also determine the physical parameters of the pixel points inserted within the blank area according to the physical parameters of the point closest to the pixel point to be inserted in the at least one adjacent region. For example, the value of the physical parameter of the closest point can be taken as the value of the physical parameter that is inserted into the pixel point.

The other contents of step 1804 may also be referred to the related content of FIG. 4 and step 402 and is not repeated here.

Operation 1805 can include performing an inverse projection transformation on the second planar image to obtain a reconstructed three-dimensional second point cloud.

The specific methods and principles of operation 1805 and operation 403 can be consistent, and the detailed description can be referred to the relevant contents of FIG. 4 and operation 403 and is not repeated here.

Thus, by discretizing the first planar image, the difficulty of inserting data can be further reduced. Also, in the present embodiment, the point insertion in the three-dimensional point cloud can be replaced by the point insertion in the planar image, which can reduce the operation difficulty of inserting data. Moreover, compared with the first point cloud, the density of the points in the second point cloud can be increased, the sparsity of the point distribution in the first point cloud can be reduced, and the user can conveniently observe objects in the corresponding scene according to the second point cloud.

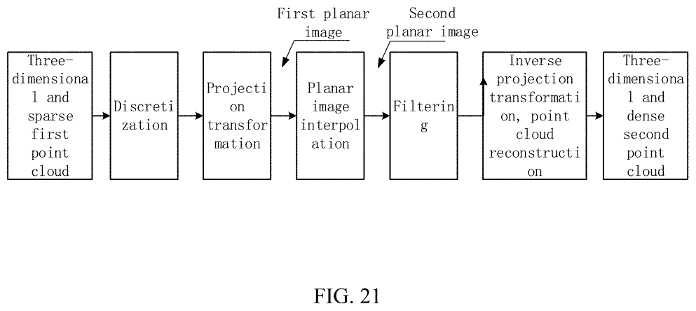

FIG. 20 is a flowchart of another method for increasing point cloud sampling density according to an embodiment of the present disclosure. FIG. 21 is a block diagram of states of the point cloud at different stages according to an embodiment of the present disclosure. Referring to FIGS. 20 and 21, a method for increasing point cloud sampling density can comprise operations 2001-2004:

Operation 2001 can include, based on a given plane, performing a projection transformation on a three-dimensional first point cloud to obtain a first planar image.

The specific methods and principles of operation 2001 and operation 401 can be consistent, and the detailed description can be referred to the relevant contents of FIG. 4 and operation 401 and is not repeated here.

Operation 2002 can include, based on pixel points around a blank area in the first planar image, inserting a plurality of pixel points into the blank area to obtain a second planar image.

The specific methods and principles of operation 2002 and operation 402 can be consistent, and the detailed description can be referred to the relevant contents of FIG. 4 and operation 402 and is not repeated here.

Operation 2003 can include filtering the second planar image based on a preset filtering algorithm.

In this embodiment, processor 200 invokes a preset filtering algorithm to filter the second planar image. The purpose of the filtering can be to improve the smoothness of the new insertion point and the surrounding point in the second plane, so that the newly inserted point can be matched with the surrounding point. The accuracy of the insertion data can be improved by filtering, and the reconstruction operation of the subsequent three-dimensional point cloud can be facilitated.

Specifically, the preset filtering algorithm can include at least one of Gaussian filtering, mean filtering, amplitude limiting filtering, median filtering, recursive mean filtering, median mean filtering, clipping mean filtering, first-order lag filtering, weighted recursive mean filtering, debounce filtering, and amplitude clipping filtering. Of course, other filtering algorithms can be implemented that, in the case of being able to smooth new insertion points and surrounding points, also fall within the scope of the present application.

Operation 2004 can include performing the inverse projection transformation based on the filtered second planar image to obtain the reconstructed three-dimensional second point cloud.

The specific methods and principles of operation 2004 and operation 403 can be consistent, and the detailed description can be referred to the relevant contents of FIG. 4 and operation 403 and is not repeated here.

Thus, in this embodiment, the pixel points can be inserted into the planar image, and the difficulty of the insertion operation can be reduced. Moreover, by filtering the second planar image, the newly inserted point can be matched with the surrounding point, so that the accuracy of the second point cloud after reconstruction can be improved, and the user can conveniently and accurately observe the object of the second point cloud.

It should be noted that the aspects of the embodiments shown in FIGS. 4-21 include different technical features, where technical features do not conflict, the various technical features may be combined with each other to obtain different schemes. For example, discretization and using the first point cloud to modify the second point cloud can be combined, discretization and filtering operations can be combined, using the first point cloud to modify the second point cloud and filtering can be combined, and so on. The corresponding scheme also falls within the scope of the present application.

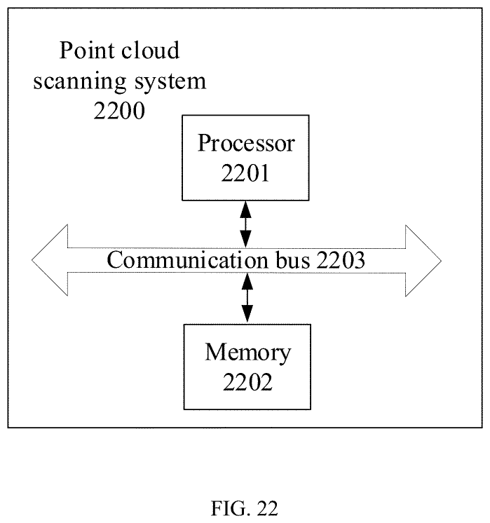

Embodiments of the present disclosure can also provide a point cloud processing system, which, according to one or more embodiments, may be a point cloud scanning system. FIG. 22 is a block diagram of another point cloud processing system according to an embodiment of the present disclosure. Referring to FIG. 22, a point cloud processing system 2200 can include at least a processor 2201 and a memory 2202. Memory 2202 can be connected to processor 2201 by a communication bus 2203 for storing computer instructions executable by processor 2201. Processor 2201 can read the computer instructions from memory 2202 and can be configured to:

based on a given plane, perform a projection transformation on a three-dimensional first point cloud to obtain a first planar image;

based on pixel points around a blank area in the first planar image, insert a plurality of pixel points into the blank area to obtain a second planar image; and

perform an inverse projection transformation on the second planar image to obtain a reconstructed three-dimensional second point cloud.

In one embodiment, the first point cloud is acquired by a distance detection device, and a mapping relationship exists between the given plane and an image plane of the distance detection device.

In one embodiment, the given plane is the image plane of the distance detection device.

In one embodiment, based on pixel points around the blank area in the first planar image, inserting the plurality of pixel points into the blank area, processor 2201 is configured to:

determine the blank area in the first planar image according to a pixel point in the first planar image;

determine whether the pixel point to be inserted in the blank region is a target point; and

when the pixel point is the target point, determine a value of a physical parameter of the target point according to a preset algorithm.

In one embodiment, the physical parameter is at least one of a depth value, a reflectivity, an angle value, and a color information.

In one embodiment, the pixel point in the blank area is a non-scanned point, and the non-scanned point refers to the pixel point corresponding to a non-scanned direction in a scene space.

In one embodiment, the pixel point in the blank area is a sky point, and the sky point refers to the pixel point corresponding to a scanned direction in a scene space but not receiving an echo information.

In one embodiment, determining whether the pixel point to be inserted in the blank region is the target point, processor 2201 is configured to:

when the pixel point to be inserted is the non-scanned point, determine that the pixel point is the target point; and/or

when the pixel point to be inserted is the sky point, determine that the pixel point is not the target point.

In one embodiment, determining whether the pixel point to be inserted in the blank region is the target point, processor 2201 is configured to:

acquire the value of the physical parameter of the pixel point around a pixel point to be inserted;

compare the value of the physical parameter with a parameter threshold to obtain a comparison result; and

determine whether the pixel point to be inserted is the target point based on the comparison result.

In one embodiment, determining whether the pixel point to be inserted is the target point based on the comparison result, processor 2201 can be configured to:

when the comparison result indicates that the value of the physical parameter is less than or equal to the parameter threshold, determine that the pixel point to be inserted is the target point; and

when the comparison result indicates that the value of the physical parameter is greater than the parameter threshold, determine that the pixel point to be inserted is not the target point.

In one embodiment, the preset algorithm is an interpolation algorithm.

In one embodiment, the interpolation algorithm is at least one of a nearest neighbor interpolation, a linear interpolation, a Lanczos interpolation algorithm, an inverse distance weighting method, a spline interpolation method, a discrete smoothing interpolation, and a trend face smoothing interpolation.

In one embodiment, based on pixel points around the blank area in the first planar image, inserting the plurality of pixel points into the blank area to obtain the second planar image, processor 2201 can be configured to:

based on a physical parameter of each pixel point in the first planar image, divide the first planar image to obtain an object contained in the first planar image and the blank area of each object; and

for the blank area of each object, based on the pixel points around the blank area, insert a plurality of pixel points into the blank area, and inserting the blank area of each object into a planar image after the pixel point as the second planar image.

In one embodiment, operation of dividing comprises at least one of semantic segmentation and instance segmentation.

In one embodiment, after performing the inverse projection transformation on the second planar image to obtain the reconstructed three-dimensional second point cloud, processor 2201 can be further configured to:

correct the second point cloud based on the first point cloud to obtain a third point cloud, the third point cloud comprising the second point cloud, and a point located in the first point cloud but not located in the second point cloud.

In one embodiment, correcting the second point cloud based on the first point cloud, processor 2201 can be configured to:

compare a physical parameter of each point in the first point cloud and a physical parameter of each point in the second point cloud; and

add points of different physical parameters to the second point cloud to obtain the third point cloud.

In one embodiment, before based on pixel points around the blank area in the first planar image, inserting the plurality of pixel points into the blank area, processor 2201 can be further configured to:

discretize the first planar image based on a preset discrete algorithm; and

determine the blank area from the discretized first planar image.

In one embodiment, discretizing the first planar image based on the preset discrete algorithm, processor 2201 can be configured to:

divide the first planar image into a plurality of regions, the plurality of regions including a partial of the blank area, the blank area including an area that does not include a point.

In one embodiment, numbers of points included within any two regions are different.

In one embodiment, each region is continuously performed at least one discretization.

In one embodiment, areas of at least a portion of the plurality of regions are different.

In one embodiment, based on pixel points around the blank area in the first planar image, inserting the plurality of pixel points into the blank area, processor 2201 can be configured to:

based on a physical parameter of a pixel point within at least one adjacent region of the blank area, determine the physical parameter of the pixel point inserted into the blank area.

In one embodiment, based on pixel points around the blank area in the first planar image, inserting the plurality of pixel points into the blank area, processor 2201 can be configured to:

based on the physical parameter of at least one adjacent region, determine the physical parameter of a pixel point inserted into the blank area, wherein the physical parameter of the region is determined based on a physical parameter of a point within the region that is closest to a distance detection device.

In one embodiment, the preset discrete algorithm comprises at least one a quadtree partitioning algorithm, a uniform segmentation algorithm, a normal segmentation algorithm, a semantic segmentation algorithm, and an example segmentation algorithm.

In one embodiment, before performing the inverse projection transformation on the second planar image to obtain the reconstructed three-dimensional second point cloud, processor 2201 can be further configured to:

filter the second planar image based on a preset filtering algorithm; and

perform the inverse projection transformation based on the filtered second planar image to obtain the reconstructed three-dimensional second point cloud.

In one embodiment, the preset filtering algorithm comprises at least one of Gaussian filtering, mean filtering, clipping filtering, median filtering, recursive mean filtering, median mean filtering, clipping mean filtering, first-order lag filtering, weighted recursive mean filtering, debounce filtering, and amplitude clipping filtering.

Embodiments of the present disclosure can also provide a non-transitory computer-readable storage medium, having stored thereon computer instructions, wherein the computer instructions can be executed by one or more processors, such as processor 200 or processor 2201, to implement operations of the method of FIGS. 4-22.

Processors according to embodiments of the disclosed subject matter, such as processor 200 and/or processor 2201, may be, but is not limited to, a micro-controller unit (MCU), a central processing unit (CPU), a digital signal processor (DSP), or the like.

Computer-readable memory, such as memory 300, according to embodiments of the disclosed subject matter can be a tangible device that can store instructions for use by an instruction execution device (e.g., a processor or multiple processors, such as distributed processors). The storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the storage medium includes each of the following (and appropriate combinations): flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer program and/or computer instructions described in this disclosure can be downloaded to an appropriate computing or processing device from a storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer program and/or computer instructions for implementing operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer program and/or computer instructions may execute entirely on a user's personal computer, notebook computer, tablet, or smartphone, entirely on a remote computer or computer server, or any combination of these computing devices. The remote computer or computer server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

Aspects of the present disclosure are described herein with reference to flowchart and block diagrams of methods, apparatus/equipment (systems), and computer program products according to embodiments of the disclosure. It will be understood by those skilled in the art that each block of the flowchart and block diagrams, and combinations of blocks in the flow diagrams and block diagrams, can be implemented by computer program and/or computer instructions.

As described in the above, in the disclosed embodiments, the first point cloud can perform a projection transformation on the three-dimensional first point cloud based on a given plane to obtain a first planar image; then, the blank area in the first planar image can be inserted into a plurality of pixel points to obtain a second planar image; and finally, an inverse projection transformation can be performed on the second planar image to obtain a reconstructed three-dimensional second point cloud. Thus, in the disclosed embodiments, the pixel points can be inserted into the planar image to reduce the difficulty of the insertion operation. Moreover, in the disclosed embodiments, compared with the first point cloud, the density of the points in the second point cloud can be increased, the sparsity of the point distribution can be reduced, and/or the user can conveniently observe objects in the corresponding scene according to the second point cloud.

It should be noted that relational terms, such as first and second, etc., are used herein to distinguish one entity or operation from another entity or operation without necessarily requiring or implying any such actual relationship or order between such entities or operations. The terms “comprises,” “comprising,” or any other variation thereof, are intended to cover a non-exclusive inclusion, such that a process, method, article, or apparatus that comprises a series of elements not only includes those elements but also includes other elements not expressly listed, or that is an element inherent to such process, method, article, or apparatus. In the absence of more constraints, elements defined by the term “comprises a . . . ” do not preclude the presence of additional similar elements in the process, method, article, or apparatus that includes the element.

The present disclosure has been described in detail with reference to the principles and implementations of the present disclosure. The foregoing description of the embodiments has been presented only to aid in the understanding of the methods of the present disclosure and its core idea. For a person of ordinary skill in the art, in accordance with the concepts of the present disclosure, it is not to be understood that the present specification is not to be construed as a limitation on the present disclosure.

What is claimed is:

1. A method for increasing point cloud sampling density, comprising:
based on a given plane, performing a projection transformation on a three-dimensional first point cloud to obtain a first planar image;
based on pixel points around a blank area in the first planar image, inserting a plurality of pixel points into the blank area to obtain a second planar image; and
performing an inverse projection transformation on the second planar image to obtain a reconstructed three-dimensional second point cloud.

2. The method of claim 1, wherein the three-dimensional first point cloud is acquired by a distance detection device, and a mapping relationship exists between the given plane and an image plane of the distance detection device.

3. The method of claim 2, wherein the given plane is the image plane of the distance detection device.

4. The method of claim 1, wherein said based on the pixel points around the blank area in the first planar image, inserting the plurality of pixel points into the blank area, comprises:
determining the blank area in the first planar image according to a pixel point in the first planar image;
determining whether the pixel point to be inserted in the blank area is a target point; and
when the pixel point is the target point, determining a value of a physical parameter of the target point according to a preset algorithm.

5. The method of claim 4, wherein the physical parameter is at least one of a depth value, a reflectivity, an angle value, and a color information.

6. The method of claim 4, wherein when the pixel point in the blank area refers to a pixel point corresponding to a non-scanned direction in a scene space, the pixel point in the blank area is a non-scanned point; and when the pixel point in the blank area refers to a pixel point corresponding to a scanned direction in the scene space but not receiving an echo information, the pixel point in the blank area is a sky point.

7. The method of claim 6, wherein said determining whether the pixel point to be inserted in the blank region is the target point, comprises:
when the pixel point to be inserted is the non-scanned point, determining that the pixel point is the target point; and
when the pixel point to be inserted is the sky point, determining that the pixel point is not the target point.

8. The method of claim 4, wherein said determining whether the pixel point to be inserted in the blank region is the target point, comprises:
acquiring the value of the physical parameter of the pixel point around the pixel point to be inserted;
comparing the value of the physical parameter with a parameter threshold to obtain a comparison result; and
determining whether the pixel point to be inserted is the target point based on the comparison result.

9. The method of claim 8, wherein said determining whether the pixel point to be inserted is the target point based on the comparison result, comprises:
when the comparison result indicates that the value of the physical parameter is less than or equal to the parameter threshold, determining that the pixel point to be inserted is the target point; and
when the comparison result indicates that the value of the physical parameter is greater than the parameter threshold, determining that the pixel point to be inserted is not the target point.

10. The method of claim 4, wherein the preset algorithm is an interpolation algorithm.

11. The method of claim 1, wherein said based on the pixel points around the blank area in the first planar image, inserting the plurality of pixel points into the blank area to obtain the second planar image, comprises:
based on a physical parameter of each pixel point in the first planar image, dividing the first planar image to obtain one or more objects contained in the first planar image and the blank area of each of the one or more objects; and
for the blank area of each of the one or more objects, based on the pixel points around the blank area, inserting the plurality of pixel points into the blank area, and inserting the blank area of each of the one or more objects into a planar image after the pixel point as the second planar image.

12. The method of claim 1, after said performing the inverse projection transformation on the second planar image to obtain the reconstructed three-dimensional second point cloud, further comprising:
correcting the reconstructed three-dimensional second point cloud based on the three-dimensional first point cloud to obtain a third point cloud, the third point cloud comprising the reconstructed three-dimensional second point cloud, and a point located in the three-dimensional first point cloud but not located in the reconstructed three-dimensional second point cloud.

13. The method of claim 12, wherein said correcting the reconstructed three-dimensional second point cloud based on the three-dimensional first point cloud, comprises:
comparing a physical parameter of each point in the three-dimensional first point cloud and a physical parameter of each point in the reconstructed three-dimensional second point cloud; and
adding points of different physical parameters to the reconstructed three-dimensional second point cloud to obtain the third point cloud.

14. The method of claim 1, before said based on the pixel points around the blank area in the first planar image, inserting the plurality of pixel points into the blank area to obtain the second planar image, further comprising:
discretizing the first planar image based on a preset discrete algorithm; and
determining the blank area from the discretized first planar image.

15. The method of claim 14, wherein said discretizing the first planar image based on the preset discrete algorithm, comprises:
dividing the first planar image into a plurality of regions, the plurality of regions including a partial of the blank area, the blank area including an area that does not include a point.

16. The method of claim 1, before said performing the inverse projection transformation on the second planar image to obtain the reconstructed three-dimensional second point cloud, further comprising:
filtering the second planar image based on a preset filtering algorithm; and
performing the inverse projection transformation based on the filtered second planar image to obtain the reconstructed three-dimensional second point cloud.

17. A point cloud processing system, comprising:
a memory; and
a processor,
wherein the memory is connected to the processor by a communication bus to store computer instructions executable by the processor, and the processor is configured to:
based on a given plane, perform a projection transformation on a three-dimensional first point cloud to obtain a first planar image;
based on pixel points around a blank area in the first planar image, insert a plurality of pixel points into the blank area to obtain a second planar image; and
perform an inverse projection transformation on the second planar image to obtain a reconstructed three-dimensional second point cloud.

18. The point cloud processing system of claim 17, wherein the three-dimensional first point cloud is acquired by a distance detection device, and a mapping relationship exists between the given plane and an image plane of the distance detection device.

19. The point cloud processing system of claim 18, wherein the given plane is the image plane of the distance detection device.

20. The point cloud processing system of claim 17, wherein for said based on the pixel points around the blank area in the first planar image, inserting the plurality of pixel points into the blank area, the processor is configured to:
determine the blank area in the first planar image according to a pixel point in the first planar image;
determine whether the pixel point to be inserted in the blank area is a target point; and
when the pixel point is the target point, determine a value of a physical parameter of the target point according to a preset algorithm.
